(19) United States
(12) Patent Application Publication
(10) Pub. No.: US 2015/0269854 A1
(43) Pub. Date: Sep. 24, 2015

(54) Computer Implemented Network Enabled Learning Aid and a System for Measuring a Learner's Progress

(71) Applicant: Tata Consultancy Services Ltd., Mumbai (IN)

(72) Inventors: Ashok Doraisamy Maharaj, Chennai (IN); Dilip Murugesan Kuppusamy, Chennai (IN); Venkatakrishnan Ranganathan, Chennai (IN); Padmaja Kakani, Chennai (IN); Adhithya Ramakumar, Chennai (IN); Suganya Nandakumar, Chennai (IN); Renuga Saraswathy, Chennai (IN)

(21) Appl. No.: 14/518,875

(22) Filed: Oct. 20, 2014

(30) Foreign Application Priority Data
Mar. 24, 2014 (IN) 990/MUM/2014

(51) Int. Cl. G09B 5/08; G06Q 30/06; G06Q 10/06; G09B 7/00; H04L 29/06

(52) U.S. Cl. CPC G09B 5/08; G09B 7/00; H04L 63/0861; G06Q 10/067; G06Q 30/06

(57) ABSTRACT

The present disclosure envisages a computer implemented network enabled learning aid, and a system and method for measuring a learner's progress for professionals and novices alike. The system implements gamified learning techniques rather than monotonous age old learning exercises. This builds up user's interest in the system and motivates the users to perform better every time. Additionally, the learning techniques implemented using the system of the present disclosure inherently improve the learning abilities of the users in a progressive manner. The system includes a study meter which is automatically calibrated with respect to the user's performances at each learning levels. The study meter cooperates with a feedback module that is configured to provide feedback or review based on the user's performance in real time. This gives the user an unbiased knowledge of the areas where the user needs to focus and improve his learning abilities accordingly.

### FIELD OF THE DISCLOSURE

The present disclosure relates to the field of learning aids and, systems and methods for measuring and assessing the progress of a learner.

### DEFINITIONS OF TERMS USED IN THE SPECIFICATION

The expression ‘user’ used hereinafter in the specification refers to but is not limited to a user, registered with the learning platform by submitting user's credentials in a predefined registration form, and managing user's profile information. The term ‘user’ represents an administrator, a student (learner), a subject matter expert and a moderator.

The expression ‘learning content’ used hereinafter in the specification refers to content driven learning for purpose of acquiring knowledge and skill in a given subject, a subject matter, a language and/or a topic.

The expression ‘network’ used hereinafter in the specification refers to a computer network, Internet, Intranet, a local area network (LAN), a wide area network (WAN), a metropolitan area network (MAN), a cellular network and a wireless network.

These definitions are in addition to those expressed in the art.

### BACKGROUND

Internet has provided wings to the ever growing field of computing which has proved to make life easy in many ways. The very existence of online concepts promised users a better method of communicating, sharing and managing of information/knowledge. Further, internet has facilitated learning in electronic form which has enabled users inhabiting in remote/rural areas or people who cannot afford costly urban educational system to communicate, share and most importantly to learn and educate using the electronic learning systems.

It has been observed that the current electronic learning systems provide tools for users to navigate through their courses. These courses are predefined and uploaded into the repository and are further managed by an authorized person or an administrator. In these systems, the user navigation functions are limited to showing users what course modules they have access to (i.e., the courses they're enrolled in) and/or where the users can interact with other users either in variety of forums or in predetermined communicating areas. Thus, current systems are consistent with the mindset of having public interfaces separated from courseware. Moreover, the current systems generally define navigation structures presented to users on the basis of a predetermined navigation path. These systems do not provide users with adequate tools for tracking their progress through their intelligence or skills, or tracking their work product as they go through courses. Further, it has been observed that majority of the courses are related to language proficiency. For such courses, the corresponding electronic learning systems aim at providing assistance in language translations rather than concentrating on developing the user's language learning skills to gain proficiency.

Accordingly, there is a long felt need for a computerized or computer-implemented system/solution that is network enabled and which will aim at providing a learning mechanism which intelligently engages users in numerous learning tasks by creating user's interest in taking up the learning exercises, thereby concentrating in developing or improving user's learning abilities to gain proficiency in a subject or language. Further, there is a need for a system that involves participation by the users and is oriented in building a community of skilled users.

### Objects

Some of the objects of the present disclosure aimed to ameliorate one or more problems of the prior art or to at least provide a useful alternative are described herein below:

An object of the present disclosure is to provide a computer implemented network enabled learning aid and a system for measuring a learner's progress.

An additional object of the present disclosure is to provide a computer implemented network enabled system for providing learning assistance to a user and improving a user's learning abilities and/or aptitude.

Another object of the present disclosure is to provide a system that uses gamification techniques for building user's interest in learning.

Yet another object of the present disclosure is to provide a system that includes an intelligent metering apparatus or a study meter that monitors users progress in real-time.

One more object of the present disclosure is to provide a system that enables users to earn badges based on the user performances.

An additional object of the present disclosure is to provide a system that enables users to utilize social networking features for information sharing and facilitating communal learning.

Another object of the present disclosure is to provide a system that generates user driven real-time analytics.

An object of the present disclosure is to provide an intelligent metering apparatus or a study meter that can be integrated with a plurality of gamified learning platforms.

### SUMMARY

The present disclosure envisages a computer implemented network enabled learning aid and a system for measuring a learner's progress.

Typically in accordance with the present disclosure the system comprises a first repository for storing, a plurality of questions and at least one answer to each of the questions. The system also comprises a second repository for storing a set of user-levels related to learning. An associating processor present in the system is configured to cooperate with the first repository and the second repository. This associating processor possesses functional elements to fetch questions and answers from the first repository and user levels from the second repository and process in accordance with a pre-determined first set of rules, the questions and answers to assign user levels of each of the questions and each of the answers, and push the assigned questions and answers into the user levels respectively. The system also comprises a third repository for storing a plurality of tasks and a standardizing processor that cooperate with the second repository and third repository and possesses functional elements to standardize each of the tasks at the user-levels in accordance with a pre-determined second set of rules. A fourth repository present in the system stores at least user related information and a user profile. The system further comprises a study meter having a plurality of meter calibration rules stored therein, and a calibrating processor provided within the study meter. The calibrating processor possesses functional elements to automatically calibrate the study meter and set an initial user-level for a first time user based on user related information stored in the fourth repository. The calibrating processor further possesses functional elements to automatically reset the user-level for a user based on the user's performance corresponding to a primary assessment level in accordance with pre-determined third set of rules. The calibrating processor cooperates with the standardizing processor to standardize the learning instruction for each user based on the user's performance in accordance with a pre-determined fourth set of rules. The system also includes a fourth processor equipped with a functional crawling element and a posting element. The crawling element is controlled by the fourth processor to establish communication with the study meter and the second repository, based on the calibration and the user-level determined by the study meter corresponding to a user, and is further controlled by the fourth processor to extract a random set of questions associated with the determined user level from the first repository in accordance with a pre-determined fifth set of rules. The posting element is controlled by the fourth processor to post the extracted questions to the user's profile. A response-registering module present in the system is configured to register a response posted by a user corresponding to a question in the user's profile. The system also comprises an evaluation module which is equipped with a response evaluator processor, a reader, a comparator and a signal generator. The response evaluator processor is configured to control in accordance with a pre-determined sixth set of rules, the reader to read the response posted corresponding to a question, the comparator to compare said response with an answer stored in the first repository for the question and evaluate a user-level corresponding to the user response and the signal generator to generate a signal for transmission to the study meter confirming a user-level or re-setting a user-level. A task-assignment module present in the system is equipped with a sixth processor to establish communication with the study meter and the evaluation module in accordance with a pre-determined seventh set of rules to assign a task in the user profile to a user in the event the study meter receives a user-level confirming signal, said task being extracted from the third repository. An assessment module then assesses the performance of the task assigned to a user. A feedback module communicates with the study meter, the evaluation module, and the assessment module to provide a feedback on the user's progress and performance corresponding to a cumulative overall performance, each task performed, each user-level cleared, and performances corresponding to each automatic calibration of the study meter on the system. The system further includes a ranking module which communicates with the evaluation module, the assessment module, and the study meter. The ranking module is configured to provide a rank to a user based on the user's performances and achieved user-level(s), wherein the ranking module distinguishably identifies the position of a user with respect to other registered-users within a group or community utilizing the system for the purpose of learning and improving learning abilities.

In accordance with the present disclosure, a method for providing learning aid and measuring a learner's progressis envisaged, the method includes following steps of:
storing, in a first repository, a plurality of questions and at least one answer to each of said questions;
storing, in a second repository, a set of user-levels related to learning;
fetching questions and answers from the first repository and the user levels from the second repository and processing in accordance with a pre-determined first set of rules, the questions and answers for assigning user levels of each of said questions and each of said answers and pushing the assigned questions and answers into said user levels respectively;
storing, in a third repository, a plurality of tasks;
standardizing each of the tasks at said user-levels in accordance with a pre-determined second set of rules;
storing, in a fourth repository, at least user related information and a user profile;
automatically calibrating a study meter based on a plurality of meter calibration rules stored therein, and setting an initial user-level for a first time user, based on user related information stored in the fourth repository and automatically resetting the user-level for a user based on the user's performance corresponding to a primary assessment level in accordance with pre-determined third set of rules, and standardizing the learning instruction for each user based on the user's performance in accordance with pre-determined fourth set of rules;
extracting a random set of questions associated with the determined user level from the second repository using a crawling element based on the calibration and the user-level determined by the study meter corresponding to a user in accordance with pre-determined fifth set of rules, and posting the extracted questions to the user's profile;
registering a response posted by a user corresponding to a question in the user's profile;
reading the response posted corresponding to a question, comparing said response with an answer stored in the first repository for the question, evaluating a user-level corresponding to the user response and generating a signal for transmission to the study meter confirming a user-level or re-setting a user-level in accordance with pre-determined sixth set of rules;
extracting a task from the third repository corresponding to the confirmed user-level and assigning said task in the user profile to a user in accordance with pre-determined seventh set of rules in the event the study meter receives a user-level confirming signal;
assessing the performance of the task assigned to a user;
generating a feedback on the user's progress and performance corresponding to a cumulative overall performance, each task performed, each user-level cleared, and performances corresponding to each automatic calibration of the study meter; and
providing a rank to a user based on the user's performances and user-level(s) achieved, wherein the step of providing a rank distinguishably identifies the position of a user with respect to other registered-users within a group or community utilizing the method for the purpose of learning and improving learning abilities.

### BRIEF DESCRIPTION OF THE ACCOMPANYING DRAWINGS

The computer implemented network enabled learning aid and the system for measuring a learner's progress will now be explained in relation to the non-limiting accompanying drawings, in which:

FIG. 1 illustrates a schematic of a computer implemented network enabled learning aid and a system for measuring a learner's progress in accordance with the present disclosure;

FIGS. 2A and 2B illustrate exemplary flowcharts for depicting the steps taken by the system 100 of FIG. 1, in accordance with the present disclosure; and

FIG. 3A and FIG. 3B illustrate a flowchart for a method of implementation of the system 100 of FIG. 1, in accordance with the present disclosure.

### DETAILED DESCRIPTION

The computer implemented network enabled learning aid and the system for measuring a learner's progress will now be described with reference to the accompanying drawings, which do not restrict the scope and ambit of the present disclosure. The description is provided purely by the way of illustration.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The description hereinafter, of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The present disclosure envisages a computer implemented network enabled learning aid and the system for measuring a learner's progress and is oriented towards imparting knowledge proficiency. The system is accessible via a network and is incorporated with social networking features to assist users to connect or collaborate with other users of the system. New users using the system are required to register themselves by providing user registration information in a pre-determined user-registration form before taking learning exercises on the system. In accordance with the present disclosure, the system is enabled to receive and store biometric information from the user during the registration process. This biometric information is used in verifying the legitimacy of the user who wishes to login into the system for the purpose of carrying out gamified learning exercises.

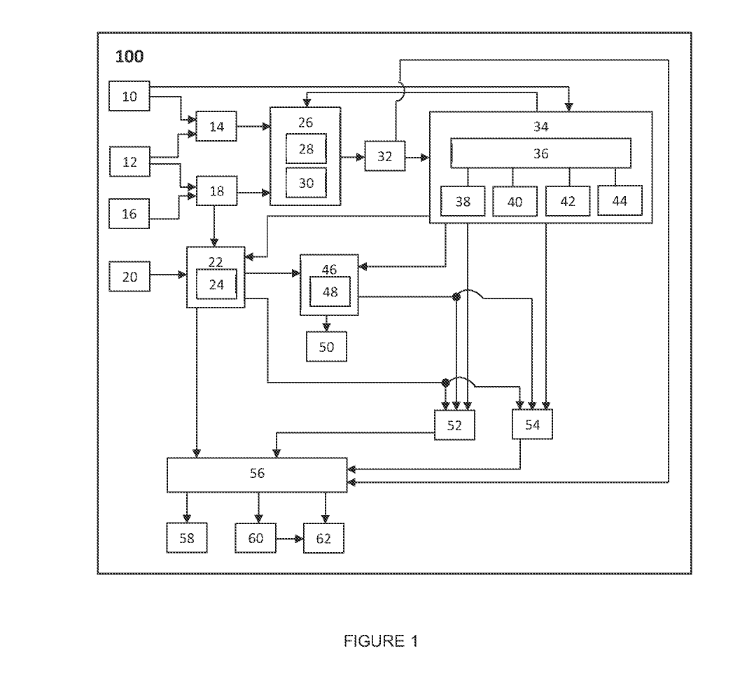

Referring to FIG. 1, there is shown a schematic of a computer implemented network enabled learning aid and a system 100 for measuring a learner's progress. The system 100, in accordance with the present disclosure is configured to group users of the system 100 into at least four user roles namely, administrator, student, subject matter expert and moderator. In accordance with the present disclosure, an administrator supports system administration functions and ensures proper implementation of the system 100. An administrator also ensures that appropriate data gathering, data sharing, and maintenance policies are implemented on the system 100. The administrator performs functions such as editing, adding, deleting, uploading and/or updating and managing the modules to maintain the system 100. A student (learner) of the system 100 is one who has registered by creating at least a profile (in part/full) with the system 100 by providing user's credentials. The student can then configure his profile with a second degree authentication by providing biometric identification for the purpose of verifying legitimacy during logging in into the system 100. A subject matter expert is one who is registered with the system 100 by creating a profile (in part/full) including information corresponding to his/her skills set and areas of expertise. The subject matter expert guides the students. A moderator is one who is registered with the system 100 and enforces governance on the system 100.

The system 100, in accordance with the present disclosure includes a first repository 10 for storing a plurality of questions and at least one answer to each of the questions. The system 100 also includes a second repository 12 for storing a set of user-levels related to learning. An associating processor 14 present in the system 100 possesses functional elements to fetch questions and answers from the first repository 10 and user levels from the second repository 12 and process the questions and answers to assign user levels of each of the questions and each of the answers in accordance with a pre-determined first set of rules and then push the assigned questions and answers into the user levels respectively. The first set of rules includes rules for assigning user levels based on the questions and answers. An administrator is enabled to manage the user-levels on the system 100. The system 100 further includes a third repository 16 for storing a plurality of tasks which are standardized around the user-levels from the second repository 12 in accordance with a pre-determined second set of rules by a standardizing processor 18. The second set of rules include rules for standardizing a plurality of tasks comprising gamified learning tasks including but not limited to comprehension, knowledge assessment exercises, quizzes and other related learning exercises. A fourth repository 20 present in the system 100 stores at least user related information and a user profile. The user related information includes but is not limited to at least registration information, user skill related information, assessed user-level(s) corresponding to the user, the assigned tasks, responses submitted by the user corresponding to the questions, performance corresponding to each task, motivational incentives received by the user, user's participation in group activities and user's progress within a group or system. The fourth repository 20 communicates with a registration module (not shown in the figure) and a biometric module (not shown in the figure). The fourth repository 20 stores the initial user's credentials and profile information as received from the registration module that directly receives information from user when the user is registering with the system 100 for the first time. The fourth repository 20 also receives and stores biometric identification corresponding to the user from the biometric module. This biometric identification is selected from the group consisting of voice recognition for speaker identification and authentication, retina recognition, DNA matching, ear shape recognition, face recognition, finger print recognition, finger geometry recognition, user's behavioral recognition, hand geometry recognition, and signature recognition. On reception of the biometric identification from the user, the legitimacy of that user is determined/verified during the user's subsequent login actions performed on the system 100. The user can then configure the user's profile with a second degree authentication i.e. biometric authentication either at the time of registration or any time after the completion of the registration process.

In accordance with the present disclosure, the system 100 includes a study meter 22 which has a plurality of meter calibration rules stored therein for automatic calibration corresponding to each registered user of the system 100. The study meter 22 is provided with a calibrating processor 24 that possesses functional elements to automatically calibrate the study meter 22 and set an initial user-level for a first time user based on user related information stored in the fourth repository 20. The calibrating processor 24 also automatically resets the user-level for a user based on the user's performance corresponding to a primary assessment level in accordance with a pre-determined third set of rules. These third set of rules include various rules for resetting the user-levels. The calibrating processor 24 further cooperates with the standardizing processor 18 to standardize the learning instruction for each user based on the user performance in accordance with a pre-determined fourth set of rules. These fourth set of rules include rules for standardizing learning instructions. The system 100 includes a fourth processor 26 to establish communication with the study meter 22, first repository 10 and second repository 12. A crawling element 28 present in the fourth processor 26 is controlled by the fourth processor 26 to establish communication with the study meter 22 and the second repository 12 to determine calibration and user-level corresponding to a user in order to extract random set of questions associated with the determined user level from the first repository 10 in accordance with a pre-determined fifth set of rules. These fifth set of rules include rules for determining calibration and user-level, and extracting questions from the first repository 10. A posting element 30 present in the fourth processor 26 is controlled by the fourth processor 26 to post the extracted questions to the user's profile. A response registering module 32 then registers a response posted by a user corresponding to a question in user's profile. This posted response is read by a reader 38 present in an evaluation module 34 with the help of a response evaluator processor 36 that controls the reader 38 in accordance with a pre-determined sixth set of rules. These sixth set of rules include rules for controlling the reader 38. The evaluation module 34 is also equipped with a comparator 40 and a signal generator 42, wherein the comparator 40 compares the response that is read by the reader 38 with an answer stored in the first repository 10 for the question and then evaluates a user-level corresponding to the user response, and the signal generator 42 generates a signal for transmission to the study meter 22 confirming a user-level or re-setting a user-level. The evaluation module 34 further includes a remedial sub-module 44 which is controlled by the response evaluator processor 36 to establish communication with the first repository 10 to evaluate correct responses and incorrect responses submitted by the user corresponding to each questions attempted by the user. The remedial sub-module 44 further cooperates with the posting element 30 of the fourth processor 26 to post a desired correct response corresponding to each incorrect responses registered on the user's profile. Based on the answers submitted by user, response-registering module 32 is enabled to confirm whether the user-level calibrated by the study meter 22 defers from the user-level judged corresponding to the user submitted answers. If the user-level confirmed by the response-registering module 32 is different from the initially calibrated user-level, the study meter 22 is enabled to calibrate itself again with the help of the calibrating processor 24 and the calibration rules. Further, the calibrating processor 24 is configured to automatically set or reset the study meter 22 based on the subsequent performances of the user corresponding to the assigned tasks. The calibrating processor 24 calibrates the study meter 22 based on the user-level of the user evaluated by the evaluation module 34 based on the user's registered responses.

In the event the study meter 22 receives a user-level confirming signal, a task-assignment module 46 present in the system 100 establishes communication with the study meter 22 and the evaluation module 34 with the help of a sixth processor 48 in accordance with a pre-determined seventh set of rules to assign a task extracted from the third repository 16 to a user in the user's profile. The seventh set of rules includes rules for establishing communication and assigning tasks to the user. The task-assignment module 16 assigns the tasks along with a time limit for completing the assigned task. An assessment module 50 present in the system 100 assesses the performance of the task assigned to a user. A feedback module 52 communicates with the study meter 22, the evaluation module 34 and the assessment module 50 to provide a feedback on the user's progress and performance corresponding to a cumulative overall performance, each task performed, each user-level cleared, and performances corresponding to each automatic calibration of the study meter 22 on the system 100. A ranking module 54 present in the system 100 communicates with the evaluation module 34, the assessment module 50 and the study meter 22 to provide a rank to a user based on the user's performances and achieved user-level(s). The ranking module 54 distinguishably identifies the position of a user with respect to other registered-users within a group or community by utilizing the system 100 for the purpose of learning and improving learning abilities. Further, the analysis performed by the ranking module 54 determines a quantifiable position/rank of the user among the other registered users in real-time. The rank provided to the user by the ranking module 54 upgrades or degrades the ranking position of the user in the ranking hierarchy of the system 100.

The system 100 further includes a performance management processor 56, a reward module 58, a performance-measuring module 60 and an analytical engine 62. The performance management processor 56 controls the reward module 58 to establish communication with the response-registering module 32, the feedback module 52, the ranking module 54 and the study meter 22 to provide a motivational-incentive to the user based on the user's performances, achieved user-level(s), and rank achieved. The performance management processor 56 also controls the performance-measuring module 60 to establish communication with the feedback module 52 to quantify the user's performance based on the assessed user-level, user's task completion time, time limit allotted to the assigned task, motivational incentives received, and ranking of the user received. The analysis performed by the performance-measuring module 60 is communicated to the feedback module 52 to provide user performance feedbacks in real-time. The analytical engine 62 is also controlled by the performance management processor 56 to establish communication with the study meter 22, the performance-measuring module 60 and the feedback module 52 for the purpose of receiving information pertinent to the user's performances. The analytical engine 62 generates a plurality of analytical reports based on the user's performances corresponding to the each assigned task and within each assigned user-level. In addition, the analytical engine 62 is further adapted to communicate the generated analytical reports to the corresponding users using the short messaging service (sms), email and notifications.

In accordance with the present disclosure, the system 100 includes a facility to provide multiple types of learning contents including learning content expressed in multiple languages for the purpose of imparting lessons and assessing the users corresponding to multiple learning contents. Additionally, the analytical engine 62 generates and communicates the analytical reports based on user's performance corresponding to each type of learning content.

In accordance with the present disclosure, the system 100 is accessed by the users via a network. The system 100 includes a revenue model (not shown in the figure) which is based on user subscription. The user can access the system 100 after purchasing the desired subscription type. These subscription types are time bound and managed by the administrator of the system 100. The revenue model implements a variety of subscription models using which revenue is collected from the users as a membership fee to access and utilize the system 100. In addition, the revenue module includes variant of subscription models for the users to purchase and avail the advanced features or functionalities available on the system 100.

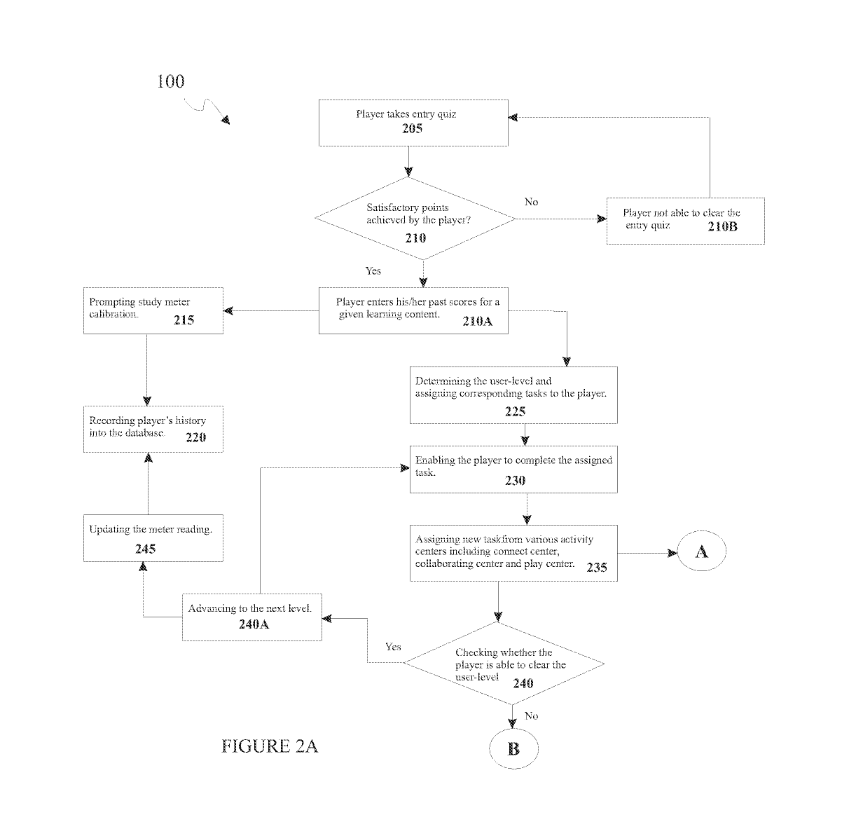

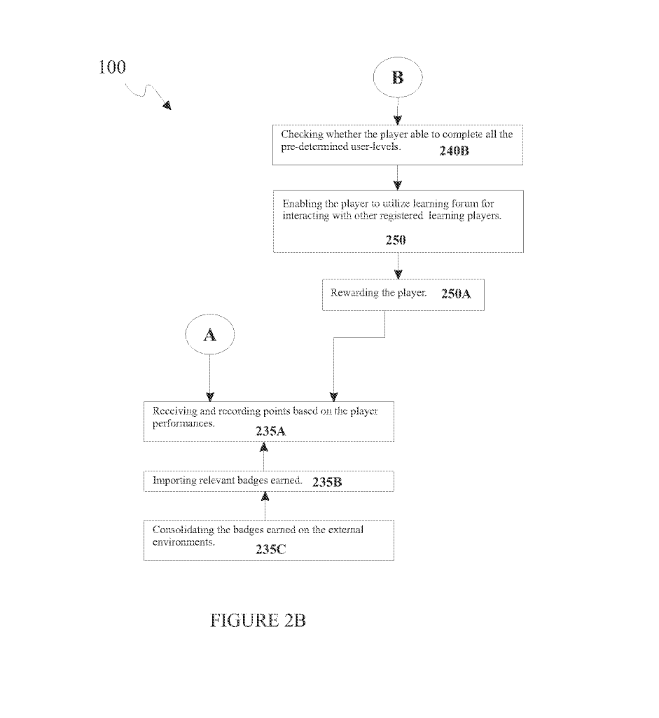

Referring to FIGS. 2A and 2B, there is shown an exemplary flowchart for depicting the steps taken by the system 100 of FIG. 1, in accordance with the present disclosure. The term ‘user’ used hereinafter in the description of the accompanying FIGS. 2A and 2B is referred as a ‘player’ who is a registered member with the system 100. The journey experienced by the player while accessing features and functionality of the system 100 after login includes the following steps:
player starts by taking entry level online quiz posted on the player's profile 205;
checking whether the player is able to achieve a threshold values or points by answering the questions in the quiz 210;
   if the points achieved by the player are greater than or equal to the threshold points, providing eligibility rights to the player to enter user's past examination scores for a given learning content 210A;
   if the points achieved by the players are less than the threshold points, not providing a clearance to the entry quiz and prompting the player to start again 210B;
if 210A, prompting a study meter to calibrate it's reading based on the performance in the entry level quiz and the examination scores provided by the player 215;
recording player's informational history into the player-information-database corresponding to the given learning content 220;
if 210A, subsequently, determining the user-level and assigning tasks corresponding to the user-level to the player based on user's performance in the entry level quiz 225;
enabling the player to complete all the tasks assigned corresponding to the user-level 230;
assigning new tasks corresponding to the user-level of the player from various activity centers including connect center, collaborate center and play center 235;
   receiving and recording points based on the player performances in completing the tasks assigned, earning badges, ranking the player on a leaderboard based on the activities done on various activity centers into the player-information-database 235A;
   consolidating and prompting the player to import all the relevant badges earned in user's profile 235B;
   consolidating the badges earned on the external environments or third party web sites 235C;
checking whether the player is able to clear the user-level 240;
   if yes, advancing the player to the next user user-level in the hierarchy 240A;
   if no, checking whether the player is able to complete all the pre-determined user-level created by the administrator on the platform 100, if all the user-levels cleared by the player 2408;
if 240B, enabling the player to utilize the learning forum for interacting with other registered players 250;
   rewarding the player based on this performances while performing activities related to the connect center, collaborate center and play center 250A;
   recording the rewards earned by the player on the system 100 and further recording into the player-information-database 235A;
if 240A, updating, the study meter reading of the previous user-level to the next advanced user-level based on the player's performance while completing the tasks assigned in the previous user-level 245; and
   recording of player's informational history into the player-information-database corresponding to the given learning content 220.

In accordance with the present disclosure, the connect center of the system 100 enables the players to communicate directly with the subject matter experts/peers registered with the system 100. It serves as a socializing zone and allows formation of networks/groups between all types of players thereby allowing discussions between them. This group(s) created by the players has to be approved by the administrator of the system 100 to be visible to other users. The connect center also houses students' profiles on a connect page. In addition, the connect center provides additional privileges player to create/join/un-join different activity groups. It serves as the socializing zone. Students profile is housed in the connect page. The subject matter experts and moderators that drive learning are introduced to the learners (students) in this connect center. The connect center additionally, hosts important documents including instructions, learning manuals and other documents that set the context for the learning in multiple formats. The players of the system 100 can then download these documents or comment on the hosted documents.

In accordance with the present disclosure, the collaborate center present in the system 100 provides peer-to-peer user engagement within the system 100. The peer-to-peer user engagement is provided by selecting a method from a group consisting of blogs, question and answers, debates and polls, discussion boards and the like. The peer-to-peer user engagement is managed and moderated by subject matter experts that are authorized to provide content in multiple forms and drive participation. The collaboration module enables users to create questions, post poll/debates, host discussions and write blogs. A user can comment/answer/reply/vote up/vote down the content created by other users. The subject matter experts can then review, rate and suggest corrections on the content posted by others users. This module also provides miles and badges to the students which can be earned by the students for creating and/or participating in the content created by peers and experts. The collaboration module enables the moderators to access the content thread and manage activities like booking, add to favorites and track activity on a content thread.

In accordance with the present disclosure, the play center is the learning area in the system 100. The play center enables the player to engage with the prescribed or assigned content for purpose of learning and advancing skills in the given learning content through multiple channels. These channels include but are not limited to podcasts, videos, quizzes, challenges, crosswords, reader's critics sections, grammar exercises and learning exercises.

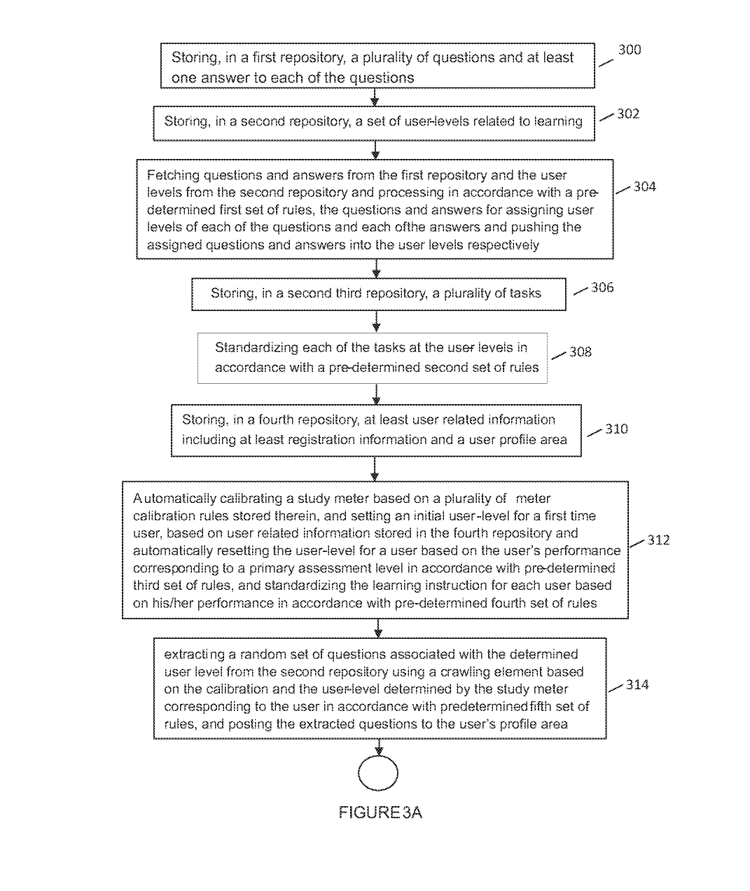

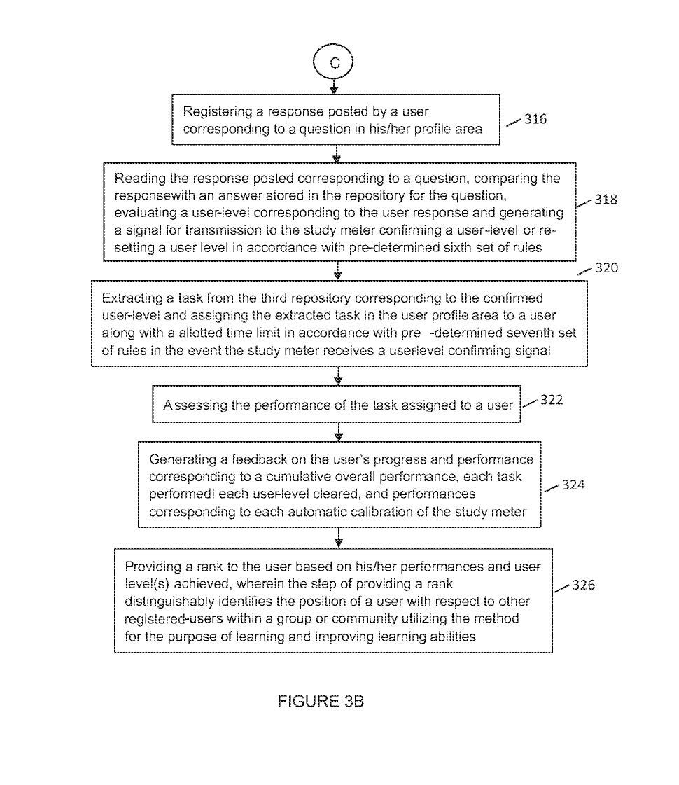

Referring to FIG. 3A and FIG. 3B, a method for providing learning aid and measuring a learner's progress is illustrated through flow diagrams. The method envisaged by the present disclosure includes the following steps:
storing, in a first repository, a plurality of questions and at least one answer to each of the questions 300;
storing, in a second repository, a set of user-levels related to learning 302;
fetching questions and answers from the first repository and the user levels from the second repository and processing in accordance with a pre-determined first set of rules, the questions and answers for assigning user levels of each of the questions and each of the answers and pushing the assigned questions and answers into the user levels respectively 304;
storing, in a third repository, a plurality of tasks 306;
standardizing each of the tasks at the user-levels in accordance with a pre-determined second set of rules 308;
storing, in a fourth repository, at least user related information including at least registration information and a user profile 310;
automatically calibrating a study meter based on a plurality of meter calibration rules stored therein, and setting an initial user-level for a first time user, based on user related information stored in the fourth repository and automatically resetting the user-level for a user based on the user's performance corresponding to a primary assessment level in accordance with pre-determined third set of rules, and standardizing the learning instruction for each user based on the user's performance in accordance with pre-determined fourth set of rules 312;
extracting a random set of questions associated with the determined user level from the second repository using a crawling element based on the calibration and the user-level determined by the study meter corresponding to the user in accordance with predetermined fifth set of rules, and posting the extracted questions to the user's profile 314;
registering a response posted by a user corresponding to a question in user's profile 316;
reading the response posted corresponding to a question, comparing the response with an answer stored in the repository for the question, evaluating a user-level corresponding to the user response and generating a signal for transmission to the study meter confirming a user-level or re-setting a user level in accordance with pre-determined sixth set of rules 318;
extracting a task from the third repository corresponding to the confirmed user-level and assigning the extracted task in the user profile to a user along with a allotted time limit in accordance with pre-determined seventh set of rules in the event the study meter receives a user-level confirming signal 320;
assessing the performance of the task assigned to a user 322;
generating a feedback on the user's progress and performance corresponding to a cumulative overall performance, each task performed, each user-level cleared, and performances corresponding to each automatic calibration of the study meter 324; and
providing a rank to the user based on user's performances and user-level(s) achieved, wherein the step of providing a rank distinguishably identifies the position of a user with respect to other registered-users within a group or community utilizing the method for the purpose of learning and improving learning abilities 326.

In accordance with the present disclosure, the step of storing, in a fourth repository 310, at least further includes the step of storing at least registration information, user skill related information, assessed user-level(s) corresponding to the user, the assigned tasks, responses submitted by the user corresponding to the questions, performance corresponding to each task, motivational incentives received by the user, user's participation in group activities, and user's progress within a group.

In accordance with the present disclosure, the step of automatically calibrating the study meter 312 includes setting or resetting the study meter based on the on the subsequent performances of the user corresponding to the assigned task further based on evaluated user-level of the user based on the user's registered responses.

In accordance with the present disclosure, the step of registering the user responses 316 includes the step of evaluating correct and incorrect responses submitted by the user corresponding to each questions attempted by the user and further includes the step of posting on the user's profile, a desired correct response corresponding to each incorrect response registered.

In accordance with the present disclosure, the method further includes the following steps:
the step of rewarding the user with a motivational-incentive based on the user's performances, the user-level(s) achieved and rank achieved;
the step of quantifying the performance of the user's performance based on the assessed user-level, user's task completion time, time limit allotted to the assigned task, motivational incentives received, and ranking of the user received; and
the step of generating a plurality of analytical reports based on the user's performance corresponding to each assigned task and within the assigned user-level.

In accordance with the present disclosure, the step of registering the user's responses 316 further includes the step of communicating the user's performance to a calibrating processor cooperating with the study meter that automatically calibrates the study meter and identifies the user's progress.

In accordance with the present disclosure, the method includes the step of purchasing a subscription for utilizing the platform for purpose of learning and improving the learning abilities.

In accordance with the present disclosure, the method includes the step of providing multiple type learning contents for the purpose of imparting learning and assessing the users corresponding to each type of learning content.

In accordance with the present disclosure, the method includes the step of receiving and storing a biometric identification during the user registration process into the fourth repository and further includes the step of verifying the user based on the biometric identification each time he/she login into the platform for the purpose learning and improving user's learning abilities.

### Technical Advancements

The technical advancements of the system as envisaged by the present disclosure include the realization of:
a computer implemented network enabled learning aid and a system for measuring a learner's progress.
a computer implemented network enabled system for providing learning assistance to a user and improving a user's learning abilities;
a system that uses gamification techniques for building user's interest in learning;
a system that includes an intelligent metering apparatus or a study meter that monitors user's progress in real-time;
a system that enables users to earn badges based on the users' performances;
a system that enables users to utilize social networking features for information sharing and facilitating communal learning;
a system that generates user driven real-time analytics;
a secure and reliable system for learning;
a system based on biometric authentication;
a system based on revenue model;
a study meter that can be integrated with a plurality of gamified learning platforms; and
a multiple content learning system based on gamification techniques.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk.

These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

1. A computer implemented network enabled learning aid and a system for measuring a learner's progress, the system comprising:
a first repository for storing, a plurality of questions and at least one answer to each of said questions;
a second repository for storing a set of user-levels related to learning;
an associating processor configured to cooperate with the first repository and the second repository and possessing functional elements to fetch questions and answers from the first repository and user levels from the second repository and process in accordance with a pre-determined first set of rules, the questions and answers to assign user levels of each of said questions and each of said answers, and push the assigned questions and answers into said user levels respectively;
a third repository for storing a plurality of tasks;
a standardizing processor configured to cooperate with the second repository and third repository and possessing functional elements for standardizing each of the tasks at said user-levels in accordance with a pre-determined second set of rules;
a fourth repository for storing at least user related information and a user profile;
a study meter having a plurality of meter calibration rules stored therein, a calibrating processor provided within the study meter, said calibrating processor possessing functional elements to automatically calibrate the study meter and set an initial user-level for a first time user, based on user related information stored in the fourth repository and automatically reset the user-level for a user based on the users performance corresponding to a primary assessment level in accordance with pre-determined third set of rules, said calibrating processor adapted to cooperate with the standardizing processor to standardize the learning instruction for each user based on user's performance in accordance with a pre-determined fourth set of rules;
a fourth processor equipped with a functional crawling element and a posting element, said crawling element controlled by the fourth processor to establish communication with the study meter and the second repository, based on the calibration and the user-level determined by the study meter corresponding to a user, the crawling element further controlled by the fourth processor to extract a random set of questions associated with the determined user level from the first repository in accordance with a pre-determined fifth set of rules, and said posting element controlled by the fourth processor to post the extracted questions to the user's profile;
a response-registering module configured to register a response posted by a user corresponding to a question in user's profile;
an evaluation module equipped with a response evaluator processor, a reader, a comparator and a signal generator, said response evaluator processor configured to control in accordance with a pre-determined sixth set of rules, the reader to read the response posted corresponding to a question, the comparator to compare said response with an answer stored in the first repository for the question and evaluate a user-level corresponding to the user response and the signal generator to generate a signal for transmission to the study meter confirming a user-level or re-setting a user-level;
a task-assignment module equipped with a sixth processor to establish communication with the study meter and the evaluation module in accordance with a pre-determined seventh set of rules to assign a task in the user profile to a user in the event the study meter receives a user-level confirming signal, said task being extracted from said third repository;
an assessment module adapted to assess the performance of the task assigned to a user;
a feedback module communicating with the study meter, the evaluation module and the assessment module, the feedback module configured to provide a feedback on the user's progress and performance corresponding to a cumulative overall performance, each task performed, each user-level cleared, and performances corresponding to each automatic calibration of the study meter on the system; and
a ranking module communicating with the evaluation module, the assessment module and the study meter, the ranking module configured to provide a rank to a user based on user's performances and achieved user-level(s), wherein said ranking module distinguishably identifies the position of a user with respect to other registered-users within a group or community utilizing the system for the purpose of learning and improving learning abilities.

2. The system as claimed in claim 1, wherein the calibrating processor is configured to automatically set or reset the study meter based on the subsequent performances of the user corresponding to the assigned task.

3. The system as claimed in claim 1, wherein the calibrating processor is further configured to calibrate the study meter based on the user-level of the user evaluated by the evaluation module based on the user's registered responses.

4. The system as claimed in claim 1, wherein the evaluation module is further equipped with a remedial sub-module, said remedial module controlled by the response evaluator processor to establish communication with the first repository to evaluate correct and incorrect responses submitted by the user corresponding to each questions attempted by the user and cooperating with the posting element of the fourth processor to post on the user's profile, a desired correct response corresponding to each incorrect response registered.

5. The system as claimed in claim 1, wherein the fourth repository configured to store user related information including at least registration information, user skill related information, assessed user-level(s) corresponding to the user, the assigned tasks, responses submitted by the user corresponding to the questions, performance corresponding to each task, motivational incentives received by the user, user's participation in group activities and user's progress within a group.

6. The system as claimed in claim 1, wherein the task-assignment module assigns the task to the user along with a time limit.

7. The system as claimed in claim 1, wherein the system further includes a performance management processor, a reward module, a performance-measuring module and an analytical engine, said performance management processor configured to control:
the reward module to establish communication with the response-registering module, the feedback module, the ranking module and the study meter to provide a motivational-incentive to the user based on user's performances, achieved user-level(s), and rank achieved;
the performance-measuring module to establish communication with the feedback module to quantify the user's performance based on the assessed user-level, user's task completion time, time limit allotted to the assigned task, motivational incentives received, and ranking of the user received; and
the analytical engine to establish communication with the study meter, the performance-measuring module and the feedback module, to generate a plurality of analytical reports based on the user's performance corresponding to each assigned task and within the assigned user-level.

8. The system as claimed in claim 7, wherein the performance-measuring module configured to register the user's performance corresponding to each assigned task is further configured to communicate the user's performance to the calibrating processor that automatically calibrates the study meter to identify the user's progress.

9. The system as claimed in claim 1, wherein the system further includes a revenue model based on user subscriptions.

10. The system as claimed in claim 1, wherein the system includes a biometric module configured to construct itself based on the user biometric identification received during user registration process, and further cooperating with a biometric authentication module configured to verify the legitimacy of user each time he/she logs into the system for the purpose learning and improving user's learning abilities.

11. The system as claimed in claim 1, wherein the system is configured to provide multiple types of learning contents for the purpose of imparting lessons and assessing the users corresponding to each type of learning content.

12. A computer implemented network enabled method for providing learning aid and measuring a learner's progress, the method comprising steps of:
storing, in a first repository, a plurality of questions and at least one answer to each of said questions;
storing, in a second repository, a set of user-levels related to learning;
fetching questions and answers from the first repository and the user levels from the second repository and processing in accordance with a pre-determined first set of rules, the questions and answers for assigning user levels of each of said questions and each of said answers and pushing the assigned questions and answers into said user levels respectively;
storing, in a third repository, a plurality of tasks;
standardizing each of the tasks at said user-levels in accordance with a pre-determined second set of rules;
storing, in a fourth repository, at least user related information and a user profile;
automatically calibrating a study meter based on a plurality of meter calibration rules stored therein, and setting an initial user-level for a first time user, based on user related information stored in the fourth repository and automatically resetting the user-level for a user based on the user's performance corresponding to a primary assessment level in accordance with pre-determined third set of rules, and standardizing the learning instruction for each user based on user's performance in accordance with pre-determined fourth set of rules;
extracting a random set of questions associated with the determined user level from the second repository using a crawling element based on the calibration and the user-level determined by the study meter corresponding to a user in accordance with pre-determined fifth set of rules, and posting the extracted questions to the user's profile;
registering a response posted by a user corresponding to a question in user's profile;
reading the response posted corresponding to a question, comparing said response with an answer stored in the first repository for the question, evaluating a user-level corresponding to the user response and generating a signal for transmission to the study meter confirming a user-level or re-setting a user-level in accordance with pre-determined sixth set of rules;
extracting a task from the third repository corresponding to the confirmed user-level and assigning said task in the user profile to a user in accordance with pre-determined seventh set of rules in the event the study meter receives a user-level confirming signal;
assessing the performance of the task assigned to a user;
generating a feedback on the user's progress and performance corresponding to a cumulative overall performance, each task performed, each user-level cleared, and performances corresponding to each automatic calibration of the study meter; and
providing a rank to a user based on user's performances and user-level(s) achieved, wherein the step of providing a rank distinguishably identifies the position of a user with respect to other registered-users within a group or community utilizing the method for the purpose of learning and improving learning abilities.

13. The method as claimed in claim 12, wherein the step of storing, in a fourth repository, at least further includes the step of storing at least registration information, user skill related information, assessed user-level(s) corresponding to the user, the assigned tasks, responses submitted by the user corresponding to the questions, performance corresponding to each task, motivational incentives received by the user, user's participation in group activities, and user's progress within a group.

14. The method as claimed in claim 12, wherein the step of automatically calibrating the study meter includes setting or resetting the study meter based on the subsequent performances of the user corresponding to the assigned task and further based on evaluated user-level of the user based on the user's registered responses.

15. The method as claimed in claim 12, wherein the step of registering the user responses includes the step of evaluating correct and incorrect responses submitted by the user corresponding to each questions attempted by the user and further includes the step of posting on the user's profile, a desired correct response corresponding to each incorrect response registered.

16. The method as claimed in claim 12, wherein the method further includes:
the step of rewarding the user with a motivational-incentive based on the user's performances, the user-level(s) achieved and rank achieved;
the step of quantifying the performance of the user's performance based on the assessed user-level, user's task completion time, time limit allotted to the assigned task, motivational incentives received, and ranking of the user received; and
the step of generating a plurality of analytical reports based on the user's performance corresponding to each assigned task and within the assigned user-level.

17. The method as claimed in claim 16, wherein the step of quantifying the performance further includes the step of communicating the user's performance to a calibrating processor cooperating with the study meter that automatically calibrates the study meter and identifies the user's progress.

18. The method as claimed in claim 12, wherein the method includes the step of purchasing a subscription for utilizing the system for purpose of learning and improving the learning abilities.

19. The method as claimed in claim 12, wherein the method includes the step of receiving and storing a biometric identification during the user registration process into the fourth repository and further includes the step of verifying the legitimacy of user based on the biometric identification each time the user logs into the system for the purpose learning and improving user's learning abilities.

20. The method as claimed in claim 12, wherein the method includes the step of providing multiple types of learning contents for the purpose of imparting lessons and assessing the users corresponding to each type of learning content.
